(19) United States
(12) Patent Application Publication
(10) Pub. No.: US 2006/0189354 A1
(43) Pub. Date: Aug. 24, 2006

(54) Base transceiver station having mobile and fixed wireless service distribution functions

(75) Inventors: Gyu-Woong Lee, Suwon-si (KR); Kwan-Soo Lee, Seoul (KR); Chang-Sup Shim, Seoul (KR); Yun-Je Oh, Yongin-si (KR); Yong-Gyoo Kim, Seoul (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/357,650

(22) Filed: Feb. 17, 2006

(30) Foreign Application Priority Data
Feb. 18, 2005 (KR) 13615/2005

(51) Int. Cl. H04B 1/38; H04M 1/00

(52) U.S. Cl. 455/561

(57) ABSTRACT

A Base Transceiver Station (BTS) for interworking a Wireless Local Area Network (W-LAN) and a mobile communication network through a Radio-over-Fiber (RoF) link is provided. The BTS having mobile and fixed wireless service distribution functions includes a Wireless Local Area Network Access Point (W-LAN AP), a wireless service function block, a Radio Frequency (RF) converter, and an optical transmitter. The wireless service function block performs transmission/reception to/from a predetermined mobile terminal via a connection for the voice call communication and data communication with an external Base Station Controller (BSC). The RF converter performs a data communication connection with the external BSC, up-converts data from the BSC into W-LAN frequency band data, and down-converts data to the BSC into baseband data. The optical transmitter transmits the up-converted data of the packet data RF converter to the W-LAN AP through a RoF link.

### CLAIM OF PRIORITY

This application claims priority under 35 U.S.C. § 119 to an application entitled “Base Transceiver Station Having Mobile and Fixed Wireless Service Distribution Functions,” filed in the Korean Intellectual Property Office on Feb. 18, 2005 and assigned Serial No. 2005-13615, the contents of which are incorporated herein by reference.

### BACKGROUND OF THE INVENTION

1. Field of the Invention

The present invention generally relates to a network system for interworking a Wireless Local Area Network (W-LAN) and a mobile communication network, and in particular, to a Base Transceiver Station (BTS) for interworking a W-LAN and a mobile communication network through a Radio-over-Fiber (RoF) link.

2. Description of the Related Art

As a high-speed wireless Internet service becomes available, there has been an active effort to early implement a Ubiquitous environment allowing mobile users to use a wireless Internet service irrespective of time, mobility, and place. The Ubiquitous environment has been implemented through standardization and early commercialization of a 4^{th}-Generation (4G) service aiming at a wireless service at 100 Mbps or higher based on the High-speed Portable Internet (HPi) and Internet Protocol version 6 (IPv6).

For Ubiquitous, much research have been conducted on a technique for interworking a mobile communications providing a mobility and a moderate/low-speed wireless Internet, and a fixed wireless communications providing no mobility and a low-cost wireless service. Now, the standardization is actively seeking for an interworking structure capable of seamlessly providing a wireless Internet service to mobile users through an interworking of a mobile communication network having a wide cell radius even when the mobile users move out of a hot spot area covered by a W-LAN service, which provides a narrow service coverage radius of 100M.

For the interworking of a mobile communication network and a W-LAN, the use of a Radio-over-Fiber (RoF) has been suggested. The RoF is a technique incorporating an optical transmission technique allowing broadband transmission irrespective of data protocol and is being highlighted as a technique for expanding the service coverage. Hereinafter, a Base Transceiver Station (BTS) of a mobile communication network and a RoF will be described to explain a configuration for interworking the mobile communication network and a W-LAN.

FIG. 1 is a block diagram of a BTS providing voice and wireless Internet services according to prior art.

Referring to FIG. 1, the BTS includes a baseband processor 100 for connection with a Base Station Controller (BSC) and an RF processor 110 for connection with a mobile terminal.

Signals for voice and data communications, transmitted from an external BSC, are modulated by the baseband processor 100 into Code Division Multiplexing (CDMA) or Global System for Mobile Communication (GSM) signals complying with 2^{nd}-Generation (2G) or 3^{rd}-Gerneation (3G) synchronous or asynchronous transmission, then transmitted to the mobile terminal through the RF processor 110. Signals from the mobile terminal are received through the RF processor 110, demodulated into CDMA or GSM signals complying with 2^{nd}-Generation (2G) or 3^{rd}-Gerneation (3G) synchronous or asynchronous transmission, and then transmitted to the BSC.

More specifically, the baseband processor 100 includes an interface unit 11 for connection with the BSC and a modulating/demodulating unit 12 that performs the modulation of a downward connection to the mobile terminal and demodulation for an upward connection to the BSC. The RF processor 110 includes a transceiver unit 13 connected to the modulating/demodulating unit 12 for wireless connection processing, an RF unit 15 for receiving data from the transceiver unit 13 and transmitting the data to the mobile terminal, a Low Noise Amplifier (LNA) 14 for receiving data from the mobile terminal through two antennas and transmitting the data to the transceiver unit 13, and a Global Positioning System (GPS) unit 15 for generating a sync clock for system synchronization through a GPS antenna.

FIG. 2 illustrates a RoF link for radio signal transmission in understanding the present invention.

Referring to FIG. 2, the RoF link is a technique for transmitting a radio signal using an optical fiber, in which a center site generates modulation data and transmits the modulation data to a remote site for wireless transmission through the remote site.

More specifically, the center site includes a modulator 21 for receiving baseband data 201 for performing a frequency modulation and RF modulation on the baseband data 201 using an RF 202, and an Electro-Optic (E/O) 22 for performing E/O conversion on RF-modulated data 203.

The remote site includes an Optic-Electro (O/E) 23 for performing O/E conversion on an optical signal 204 transmitted from the center site through an optical transmission line and an antenna for transmitting an O/E-converted RF modulation signal 205 as an RF signal.

Such a RoF can transmit various forms of radio signals on the optical transmission line through O/E conversion irrespective of the forms of transmitted electric signals. In addition, attenuation in the air or the limit of a transmission distance due to obstacles in wireless remote communication can be overcome using a low-loss optical fiber. Moreover, shadow area minimization and service coverage expansion can be achieved for a mobile communication system such as a 3G system.

The BTS used in a conventional mobile communication network is expensive to rent, maintain, and operates differently for 2G and 3G services. Since a fixed wireless service such as a W-LAN has a narrow service coverage radius of 100M, the establishment of an additional Access Point (AP) and a network for the fixed wireless service is required for achieving a wide service coverage.

Accordingly, to provide mobile communication and fixed wireless communication in a public area having a limited service coverage, services must be provided through independent network establishment and management, resulting in a redundant investment and separate management and maintenance costs for separate network establishment. Therefore, there is a need to incorporate a W-LAN system into a BTS with a limited coverage area and efficiently manage the mobile communication in an economical manner.

### SUMMARY OF THE INVENTION

One aspect of the present invention is to provide a Base Transceiver Station (BTS) having both the mobile and fixed wireless distribution functions for interworking a Wireless Local Area Network (W-LAN) and a mobile communication network, in which a fixed wireless service is available using a packet data service of the mobile communication network.

In one embodiment, there is provided a BTS having mobile and fixed wireless service distribution functions. The BTS includes a Wireless Local Area Network Access Point (W-LAN AP), a wireless service function block, a Radio Frequency (RF) converter, and an optical transmitter. The wireless service function block performs transmission to and reception from a predetermined mobile terminal using a mobile communication through connection for voice call communication and data communication with an external Base Station Controller (BSC). The RF converter performs the data communication connection with the external BSC, up-converts data from the BSC into W-LAN frequency band data, and down-converts data to the BSC into baseband data. The optical transmitter transmits the up-converted data of the packet data RF converter to the W-LAN AP through a RoF link.

### BRIEF DESCRIPTION OF THE DRAWINGS

The above features and advantages of the present invention will become more apparent from the following detailed description when taken in conjunction with the accompanying drawings in which:

FIG. 1 is a block diagram of a Base Transceiver Station (BTS) providing a voice call and a wireless Internet service of a mobile communication service according to a prior art;

FIG. 2 illustrates a Radio-over-Fiber (RoF) link for radio signal transmission in connection with the present invention;

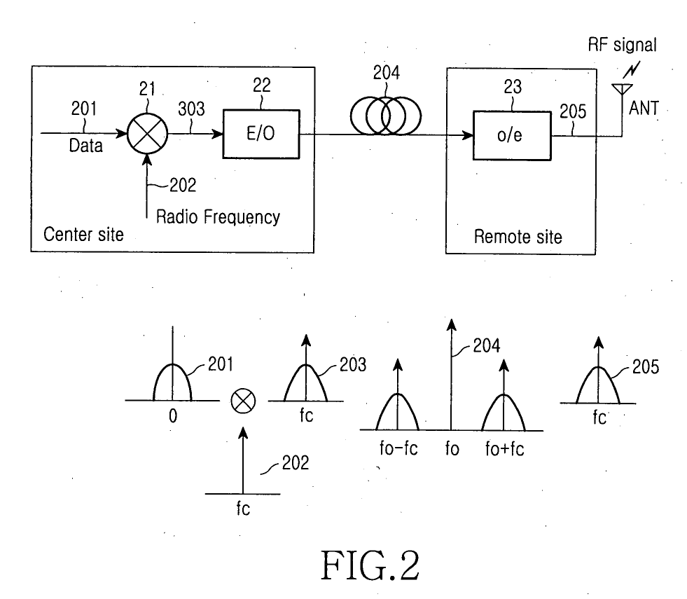

FIG. 3 is a block diagram of a BTS having mobile and fixed wireless service distribution functions according to the present invention; and

FIG. 4 illustrates a network using a BTS having mobile and fixed wireless service distribution functions according to the present invention.

### DETAILED DESCRIPTION

An embodiment of the present invention will now be described in detail with reference to the annexed drawings. For the purposes of clarity and simplicity, a detailed description of well known functions and configurations incorporated herein has been omitted.

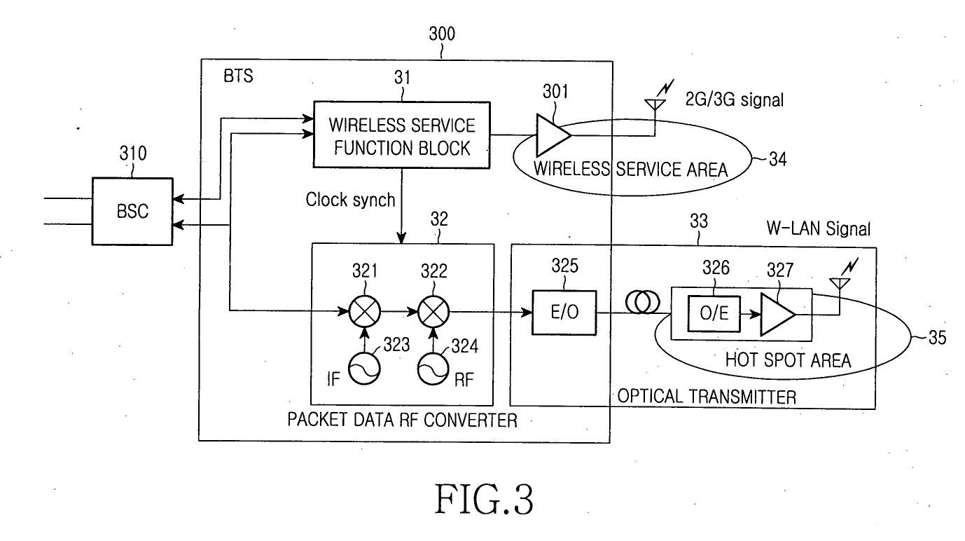

FIG. 3 is a block diagram of a Base Transceiver Station (BTS) 300 having mobile and fixed wireless service distribution functions according to the present invention.

Referring to FIG. 3, the BTS 300 is connected to a single W-LAN AP through a Radio-over-Fiber (RoF) link of an optical transmitter 33. The BTS 300 provides a wireless service area 34 including voice connection and data communication through its mobile communication antenna, and provides a hot spot area 35 through the W-LAN AP connected through the RoF link.

To this end, the BTS 300 includes a wireless service function block 31 that performs transmission to and reception from a mobile terminal using mobile communication through a connection for voice call communication and data communication with an external Base Station Controller (BSC) 310, a packet data Radio Frequency (RF) converter 32 that transmits data to the W-LAN AP through a data communication connection to the BSC 310, and the optical transmitter 33 that transmits data transmitted from the packet data RF converter 32 to the W-LAN AP through the RoF link.

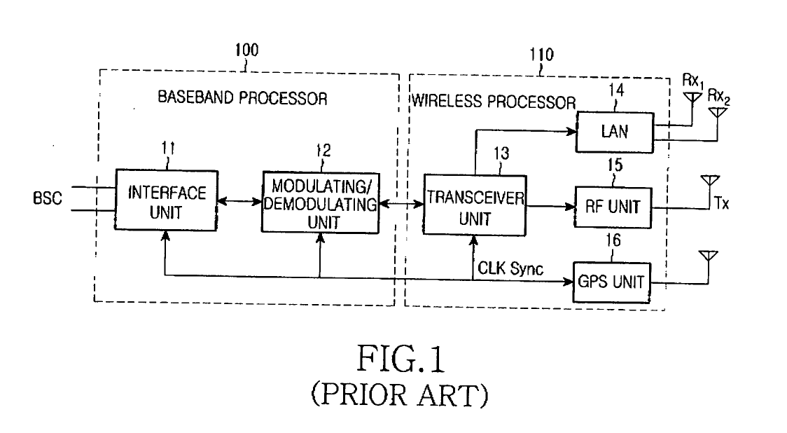

The wireless service function block 31 has the same configuration as that in the conventional BTS. That is, as shown in FIG. 1, the wireless service function block 31 includes the baseband processor 100 and the RF processor 110. The baseband processor 100 includes the interface unit 11 for connection with the BSC and the modulating/demodulating unit 12 that performs modulation for downward connection to the mobile terminal and demodulation for upward connection to the BSC. The RF processor 110 includes the transceiver unit 13 connected to the modulating/demodulating unit 12 for wireless connection processing, the RF unit 15 for receiving data from the transceiver unit 13 and transmitting the data to the mobile terminal, the Low Noise Amplifier (LNA) 14 for receiving data from the mobile terminal through two antennas and transmitting the data to the transceiver unit 13, and the Global Positioning System (GPS) unit 15 for generating a sync clock for system synchronization through a GPS antenna.

The packet data RF converter 32 includes an Intermediate Frequency (IF) generator 323 that generates an IF for modulation of baseband data from the BSC 310 into IF band data via a data communication connection with the BSC 310, an IF modulator 321 that modulates input the baseband data using the generated IF, a RF generator 324 that generates an RF for modulation of IF-modulated data into RF band data for a W-LAN, and an RF modulator 322 that modulates IF-modulated data into the RF band data for the W-LAN using the generated RF. While a downward signal (from the BSC to the W-LAN AP) is taken as an example herein, it should be noted that the same description can be applied to an upward signal, thus the discussion of the upward signal is omitted. Hence, RF band data for the W-LAN is input from the W-LAN AP and is modulated into baseband data for transmission to the BSC.

The optical transmitter 33 includes an Electro-Optic (E/O) converter 325 for transmitting data that is finally up-converted into RF band data by the RF modulator 322 to the W-LAN AP through the RoF link and the W-LAN AP that provides a hot spot area for a W-LAN service.

Packet data provided to the BTS 300 for a W-LAN service is transmitted to the packet data RF converter 32 after being branched, first up-converted in an IF stage (321 and 323), and then finally up-converted into RF band data for a W-LAN service in an RF stage (322 and 324). The up-converted data is E/O-converted by the E/O converter 325 and is then transmitted to the W-LAN AP through an optical fiber. The W-LAN AP includes an Optic-Electro (O/E) converter 326 for converting an optical signal transmitted through the optical fiber into an electric signal and a wireless transmitter 327 for wirelessly transmitting the electric signal according to W-LAN protocol. A sync clock of the packet data RF converter 32 for a W-LAN service is used for synchronization of the entire system with a GPS clock from the wireless service function block 31.

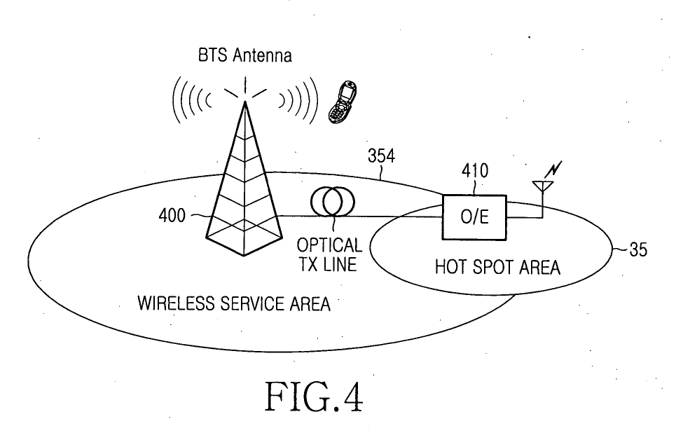

FIG. 4 illustrates a network using a BTS having mobile and fixed wireless service distribution functions according to the present invention.

Referring to FIG. 4, the network configures a wireless service area 354 through a wireless antenna 400 using the mobile communication capability of the BTS. The BTS is connected to a W-LAN AP, which provides a hot spot area 35 through a RoF link. Thus, as shown in FIG. 4, a W-LAN service is provided within a cell range of a mobile communication network and a data service can be provided to mobile users through the mobile communication network through an interworking algorithm when the mobile users move out of the hot spot area 35 of the W-LAN AP.

As described above, according to the present invention, by incorporating a W-LAN AP using a RoF link into a BTS, mobile communication and fixed wireless communication are available through a single base station without a need for additional system establishment.

While the present invention has been shown and described with reference to a preferred embodiment thereof, it will be understood by those skilled in the art that various changes in form and details may be made therein without departing from the spirit and scope of the invention.

What is claimed is:

1. A Base Transceiver Station (BTS) having mobile and fixed wireless service distribution functions, which includes a Wireless Local Area Network Access Point (W-LAN AP), the BTS comprising:
a wireless service block for performing a communication with a mobile terminal via a connection for a voice call communication and a data communication with an external Base Station Controller (BSC);
a Radio Frequency (RF) converter for performing a data communication connection with the external BSC, up-converting data from the BSC into W-LAN frequency band data, and down-converting data to the BSC into baseband data; and
an optical transmitter for transmitting the up-converted data of the packet data RF converter to the W-LAN AP through a Radio-over-Frequency (RoF) link.

2. The BTS of claim 1, wherein the wireless service function block comprises:
an interface unit for connection with the external BSC;
a modulating/demodulating unit for performing a modulation for a downward connection to the terminal and a demodulation for an upward connection to the BSC;
a transceiver unit connected to the modulating/demodulating unit for a wireless connection process;
an RF unit for receiving transmission data from the transceiver unit and transmitting the received data to the mobile terminal;
a Low Noise Amplifier (LNA) for receiving data from the mobile terminal and transmitting the received data to the transceiver unit; and
a Global Positioning System (GPS) unit for generating a sync clock for system synchronization through a GPS antenna and transmitting the sync clock to the wireless service block.

3. The BTS of claim 1, wherein the packet data RF converter comprises:
an Intermediate Frequency (IF) generator for generating an IF for a modulation of baseband data from the BSC into IF band data through the data communication connection with the BSC;
an IF modulator for modulating the baseband data using the generated IF;
an RF generator for generating an RF for a modulation of the IF-modulated data into RF band data for the W-LAN AP; and
an RF modulator for modulating-the IF-modulated data into the RF band data for the W-LAN AP using the generated RF.

4. The BTS of claim 1, wherein the optical transmitter comprises:
an Electro-Optic (E/O) converter for performing E/O conversion on data that is up-converted into the RF band data by the packet data RF converter; and
an optical transmission line for connecting the E/O converter and the W-LAN AP.

5. A Base Transceiver Station (BTS) for providing mobile and wireless services including a Wireless Local Area Network Access Point (W-LAN AP), comprising:
a wireless service block, in communication with an external Base Station Controller (BSC), for providing communication to a mobile terminal;
a Radio Frequency (RF) converter for performing a data communication with the external BSC, up-converting data from the BSC into W-LAN frequency band data, and down-converting data to the BSC into baseband data; and
an optical transmitter for transmitting the up-converted data from the RF converter to the W-LAN AP using a Radio-over-Frequency (RoF) link.

6. The BTS of claim 5, wherein the wireless service block comprises:
an interface unit for connection with the external BSC;
a modulating/demodulating unit;
a transceiver unit coupled to the modulating/demodulating unit;
an RF unit for forwarding data from the transceiver unit to the mobile terminal;
a Low Noise Amplifier (LNA) for processing data from the mobile terminal to the transceiver unit; and
a Global Positioning System (GPS) unit for generating a sync clock for a system synchronization through a GPS antenna and transmitting the sync clock to the wireless service block.

7. The BTS of claim 5, wherein the packet data RF converter comprises:
an Intermediate Frequency (IF) generator for generating an IF for modulation of baseband data from the BSC into IF band data through the data communication with the BSC;
an IF modulator for modulating the baseband data using the generated IF;
an RF generator for generating an RF for modulation of the IF-modulated data into RF band data for the W-LAN AP; and
an RF modulator for modulating the IF-modulated data into the RF band data for the W-LAN AP using the generated RF.

8. The BTS of claim 5, wherein the optical transmitter comprises:
an Electro-Optic (E/O) converter for performing E/O conversion on data that is up-converted into the RF band data by the RF converter; and
an optical transmission line for coupling the E/O converter and the W-LAN AP.
